(19) United States
(12) Patent Application Publication
(10) Pub. No.: US 2003/0212643 A1
(43) Pub. Date: Nov. 13, 2003

(54) System and method to combine a product database with an existing enterprise to model best usage of funds for the enterprise

(76) Inventors: Doug Steele, Fort Collins, CO (US); Randy Campbell, Fort Collins, CO (US); Katherine Hogan, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/140,932

(22) Filed: May 9, 2002

(51) Int. Cl. G06G 7/00; G06F 17/60

(52) U.S. Cl. 705/400; 705/1; 705/28

(57) ABSTRACT

A data center has a network of resources with one or more virtual networks within it. Each virtual network represents an enterprise. A return on investment (ROI) analysis is performed for dollars or other currency spent toward achieving optimal performance within an enterprise. An analysis is performed using the amount of money available to spend and the product database as inputs to return options on the best way or ways to spend that money to achieve optimal performance and/or redundancy within the enterprise. A product database containing costs is combined with existing analysis tools to suggest improved or replacement resources. The combined report puts a dollar value on replacement resources and estimates the cost of increasing performance/capacity of a customer enterprise.

### CROSS REFERENCE TO RELATED APPLICATIONS

This application is related to U.S. patent application Ser. No. 09/______ (Docket No. 10019960-1) to D. Steele, K. Hogan, R. Campbell, and A. Squassabia, entitled “System And Method For Analyzing Data Center Enterprise Information Via Backup Images”; U.S. patent application Ser. No. 09/______ (Docket No. 10019947-1) to D. Steele, R. Schloss, R. Campbell, and K. Hogan, entitled “System And Method For Remotely Monitoring And Deploying Virtual Support Services Across Multiple Virtual LANs (VLANS) Within A Data Center”; and U.S. patent application Ser. No. 09/______ (Docket No. 10019948-1) to D. Steele, K. Hogan, and R. Schloss, entitled “System And Method For An Enterprise-To-Enterprise Compare Within A Utility Data Center (UDC), all applications filed concurrently herewith by separate cover and assigned to a common assignee, and herein incorporated by reference in their entirety.

### BACKGROUND

Data centers and timesharing have been used for over 40 years in the computing industry. Timesharing, the concept of linking a large numbers of users to a single computer via remote terminals, was developed at MIT in the late 1950s and early 1960s. A popular timesharing system in the late 1970's to early 1980's was the CDC Cybernet network. Many other networks existed. The total computing power of large mainframe computers was typically more than the average user needed. It was therefore more efficient and economical to lease time and resources on a shared network. Each user was allotted a certain unit of time within a larger unit of time. For instance, in one second, 5 users might be allotted 200 microseconds apiece, hence, the term timesharing. These early mainframes were very large and often needed to be housed in separate rooms with their own climate control.

As hardware costs and size came down, mini-computers and personal computers began to be popular. The users had more control over their resources, and often did not need the computing power of the large mainframes. These smaller computers were often linked together in a local area network (LAN) so that some resources could be shared (e.g., printers) and so that users of the computers could more easily communicate with one another (e.g., electronic mail, or e-mail, instant chat services as in the PHONE facility available on the DEC VAX computers).

As the Information Technology (IT) industry matured, software applications became more memory, CPU and resource intensive. With the advent of a global, distributed computer networks, i.e., the Internet, more users were using more software applications, network resources and communication tools than ever before. Maintaining and administering the hardware and software on these networks could be a nightmare for a small organization. Thus, there has been a push in the industry toward open applications, interoperable code and a re-centralization of both hardware and software assets. This re-centralization would enable end users to operate sophisticated hardware and software systems, eliminating the need to be entirely computer and network literate, and also eliminating direct maintenance and upgrade costs.

With Internet Service Providers (ISPs), Application Service Providers (ASPs) and centralized Internet and Enterprise Data Centers (IDCs), the end user is provided with up-to-date hardware and software resources and applications. The centers can also provide resource redundancy and “always on” capabilities because of the economies of scale in operating a multi-user data center.

Thus, with the desire to return to time and resource sharing among enterprises (or organizations), in the form of IDCs, there is a need to optimize the center's resources while maintaining a state-of-the-art facility for the users. There is also a need to provide security and integrity of individual enterprise data and ensure that data of more than one enterprise, or customer, are not co-mingled. In a typical enterprise, there may be significant downtime of the network while resources are upgraded or replaced due to failure or obsolescence. These shared facilities must be available 24-7 (i.e., around the clock) and yet, also be maintained with state-of-the art hardware and software.

A typical IDC of the prior art consists of one or more separate enterprises. Each customer leases a separate LAN within the IDC, which hosts the customer's enterprise. The individual LANs may provide always-on infrastructure, but require separate maintenance and support. When an operating system requires upgrade or patching, each system must be upgraded separately. This can be time intensive and redundant.

There are a number of tools and systems in the prior art for measuring performance and run time metrics of systems. These tools typically analyze only performance criteria and not costs. It is therefore difficult to calculate return on investment or model the best usage per dollar spent for systems using tools of the prior art.

### SUMMARY

According to one embodiment of the present invention, a customer enterprise has a network of resources such as computers, network and storage devices, etc. Present support systems provide ways to remotely troubleshoot and analyze the health of the entire customer enterprise. An embodiment of the present invention addresses a way to model the efficiency and propose a cost/benefit analysis regarding the overall effectiveness of the customer enterprise.

An advantage of the present system and method is the combination of a product database containing cost and other information with existing analysis tools to suggest improved or replacement resources. Runtime performance metrics are retrieved from an enterprise customer's environment. At least one performance modeling tool is executed on the runtime performance metrics of the enterprise, where the execution is performed remotely from the enterprise. This reduces the runtime load on the enterprise under investigation. An inventory of components in the enterprise are identified. The cost data in the products database corresponds to the inventory of possible components used in the enterprise. The cost data is applied from the products database to the results of the performance modeling tools. A combined report can put a dollar value on replacement resources as well as estimate the basic cost of increasing performance/capacity of a customer enterprise. The dollar amounts retrieved from the product database, as well as preferred budgets, are used to recommend the actual updates or modifications to the enterprise.

### DESCRIPTION OF THE DRAWINGS

The detailed description will refer to the following drawings, wherein like numerals refer to like elements, and wherein:

FIG. 1 is a block diagram showing an embodiment of a Utility Data Center (UDC) with virtual local area networks (VLANs);

FIG. 2 is a hierarchical block diagram representing the two VLAN configurations within a UDC, as shown in FIG. 1;

FIG. 3 is a block diagram of an embodiment of a UDC with multiple control planes with oversight by a NOC, and supported by an outside entity;

FIG. 4 is a block diagram of an embodiment of a control plane management system of a UDC;

FIG. 5 is a block diagram of an embodiment of a management portal segment layer of a UDC;

FIG. 6 is a block diagram of an embodiment of a high availability observatory (HAO) support model of a UDC;

FIG. 7 is a block diagram of a virtual support node (VSN) and VLAN tagging system used to segregate the VLANs of a UDC;

FIG. 8 is a block diagram of support services through firewalls as relates to a UDC;

FIG. 9 is a block diagram representing a UDC connected with an embodiment of a best usage modeler; and

FIG. 10 is a flow diagram showing a method for performing best usage modeling analysis.

### DETAILED DESCRIPTION

The numerous innovative teachings of the present application will be described with particular reference to the presently described embodiments. However, it should be understood that this class of embodiments provides only a few examples of the many advantageous uses of the innovative teachings herein. In general, statements made in the specification of the present application do not necessarily delimit any of the various claimed inventions. Moreover, some statements may apply to some inventive features but not to others.

An embodiment of the present invention addresses the problem of how to more effectively plan and model inefficiencies in a customer environment, or enterprise, as a whole. Runtime performance metrics are retrieved from an enterprise, or customer's environment. In some embodiments, the customer enterprise resides in a utility data center. Commercial-off-the-shelf (COTS) modeling tools are used to ascertain performance and other metrics associated with the enterprise. A database holds an inventory of all components in the enterprise, along with the runtime metrics collected. A product database holds information regarding products used in one or more customer enterprises along with associated cost, configuration and performance data. Another database holds historical information regarding other customer enterprises, including their associated configurations and run-time metric, or performance data. In one embodiment, the cost data from the products database is applied to results of the COTS tools, to determine a return on investment (ROI) recommendation.

An embodiment of the present invention used in conjunction with a data center combines existing support tools/agents with remote customer enterprise support to collect and monitor the computing resources of a customer enterprise. Information collected includes an inventory of resources, resource load and resource costs. A price/performance modeling and analysis system is capable of suggesting performance levels and associated cost based on an identifiable set of “like customer enterprises” within the overall set of remotely monitored customers. This presents a clear business advantage in terms of available services offered to customers trying to plan and manage expensive enterprise environments. End-customers no longer need to guess at what an upgrade might do for their environment as the system and method described herein can often identify and report on like enterprises that have already made a similar upgrade.

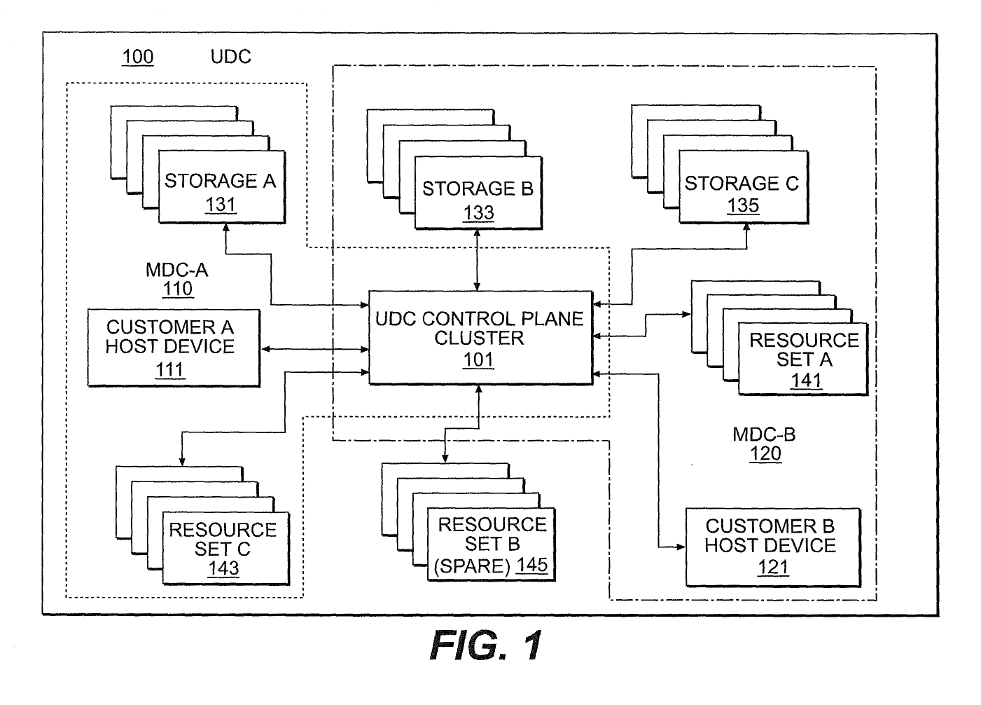

Referring now to the drawings, and in particular to FIG. 1, there is shown a simplified embodiment of a UDC 100 with two VLANs, or mini-data centers (MDCs) 110 and 120. MDC-A 110 comprises a host device 111; resources 143; and storage 131. MDC-B 120 comprises a host device 121; resources 141; and storage 133 and 135. A UDC control plane manager 101 controls the virtual MDC networks. Spare resources 145 are controlled by the control plane manager 101 and assigned to VLANs, as necessary. A UDC control plane manager 101 may comprise a control plane database, backup management server, tape library, disk array, network storage, power management appliance, terminal server, SCSI gateway, and other hardware components, as necessary. The entire UDC network here is shown as an Ethernet hub network with the control plane manager in the center, controlling all other enterprise devices. It will be apparent to one skilled in the art that other network configurations may be used, for instance a daisy chain configuration.

In this embodiment, one control plane manager 101 controls MDC-A 110 and MDC-B 120. In systems of the prior art, MDC-A and MDC-B would be separate enterprise networks with separate communication lines and mutually exclusive storage and resource devices. In the embodiment of FIG. 1, the control plane manager 101 controls communication between the MDC-A 110 and MDC-B 120 enterprises and their respective peripheral devices. This is accomplished using VLAN tags in the message traffic. A UDC may have more than one control plane controlling many different VLANs, or enterprises. The UDC is monitored and controlled at a higher level by the network operation center (NOC)(not shown).

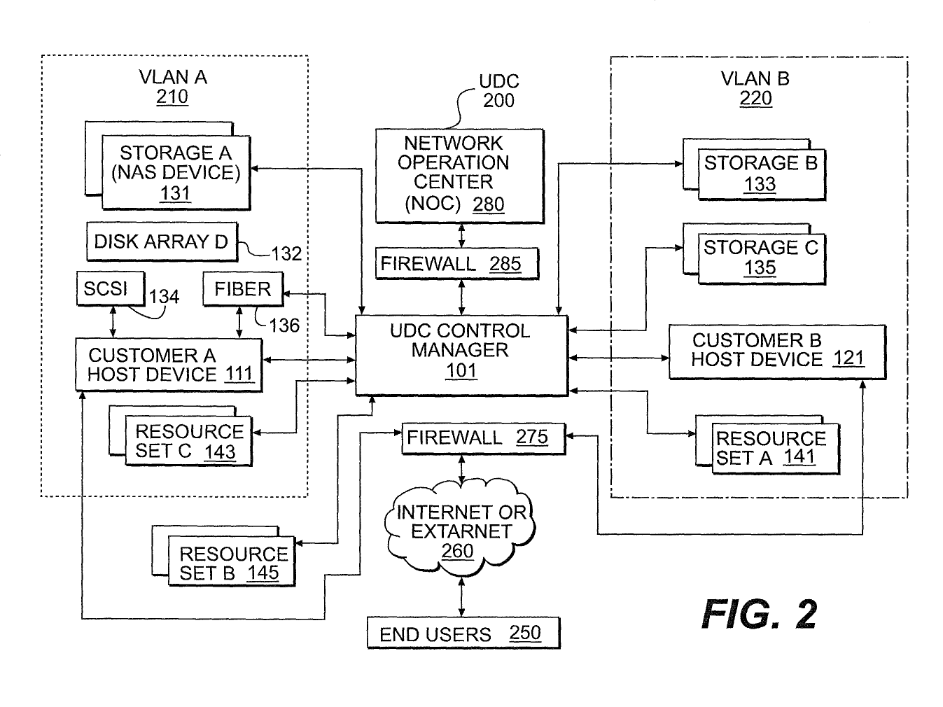

Referring now to FIG. 2, there is shown an alternate hierarchical representation 200 of the two virtual networks (VLANs) in a UDC, as depicted in FIG. 1. VLAN A 210 is a hierarchical representation of the virtual network comprising MDC-A 110. VLAN B 220 is a hierarchical representation of the virtual network comprising MDC-B 120. The control plane manager 101 controls message traffic between the MDC host device(s) (111 and 121), their peripheral devices/resources (131, 132, 143, 133, 135 and 141). An optional fiber of SCSI (small computer system interface) network 134, 136 may be used so that the VLAN can connect directly to storage device 132. The fiber network is assigned to the VLAN by the control plane manager 101. The VLANs can communicate to an outside network, e.g., the Internet 260, directly through a firewall 275. It will be apparent to one skilled in the art that the enterprises could be connected to the end user 250 through an intranet, extranets or another communication network. Further, this connection may be wired or wireless, or a combination of both.

The control plane manager 101 recognizes the individual VLANs and captures information about the resources (systems, routers, storage, etc.) within the VLANs through a software implemented firewall. It monitors support information from the virtual enterprises (individual VLANs). The control plane manager also provides proxy support within the UDC control plane firewall 275 which can be utilized to relay information to and from the individual VLANs. It also supports a hierarchical representation of the virtual enterprise, as shown in FIG. 2. An advantage of a centralized control plane manager is that only one is needed for multiple VLANs. Prior art solutions required a physical support node for each virtual enterprise (customer) and required that support services be installed for each enterprise.

The network operation center (NOC) 280 is connected to the UDC control plane manager 101 via a firewall 285. The UDC control plane manager 101 communicates with the VLANs via a software implemented firewall architecture. In systems of the prior art, the NOC could not support either the control plane level or the VLAN level because it could not monitor or maintain network resources through the various firewalls. An advantage of the present invention is that the NOC 280 is able to communicate to the control plane and VLAN hierarchical levels of the UDC using the same holes, or trusted ports, that exist for other communications. Thus, an operator controlling the NOC 280 can install, maintain and reconfigure UDC resources from a higher hierarchical level than previously possible. This benefit results in both cost and timesavings because multiple control planes and VLANs can be maintained simultaneously.

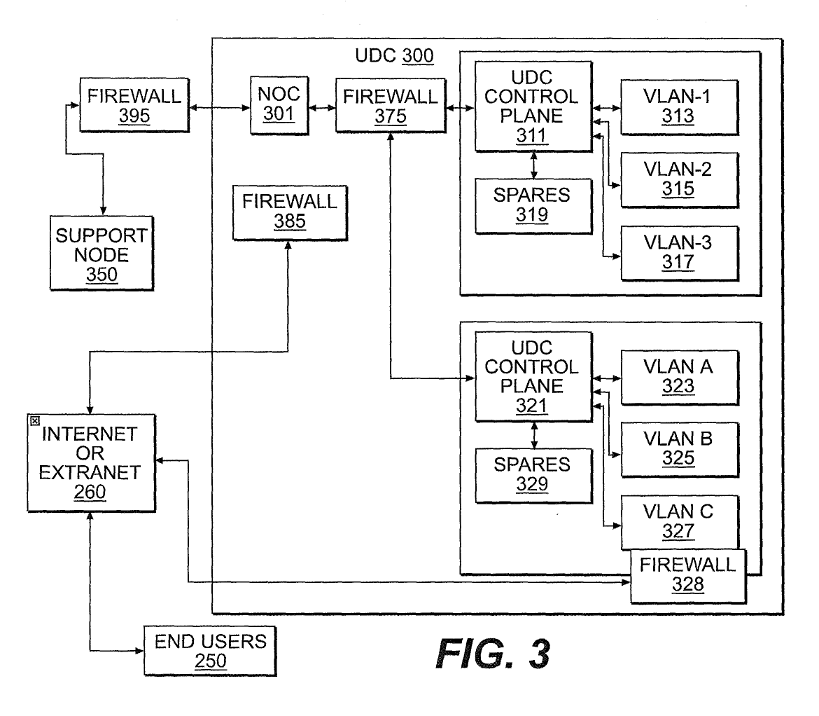

Referring now to FIG. 3, there is shown a simplified UDC 300 with multiple control plane managers 311 and 321 controlling several VLANs 313, 315, 317, 323, 325, and 327. In addition, the control planes control spare resources 319 and 329. A higher level monitoring system, also known as a network operation center (NOC) 301, is connected to the control planes 311 and 321 via a firewall 375. A VLAN can be connected to an outside network through a firewall as shown at VLAN C 327 and firewall 328. The NOC 301 has access to information about each VLAN 313, 315, 317, 323, 325 and 327 via a virtual protocol network (VPN). Typically, a human operator will operate the NOC and monitor the entire UDC. The operator may request that a control plane 311 reconfigure its virtual network based on performance analysis, or cost benefit analysis.

For example, if a resource dedicated to VLAN-1 (313) fails, the control plane 311 will automatically switch operation to a redundant resource. Because the network uses an always-on infrastructure, it is desirable to configure a spare from the set of spares 319 to replace the faulty resource, as a new redundant dedicated resource. In systems of the prior art, this enterprise would be monitored and maintained separately. In this embodiment, the NOC 301 monitors the control planes 311 and 321, as well as, the VLANs 313, 315, 317, 323, 325 and 327. Thus, if none of the spares 319 are viable substitutions for the failed component, the NOC operator can enable one of the spares 329 to be used for control plane 311 rather than control plane 321. Depending on the physical configuration of the UDC, this substitution may require a small update in the VLAN configurations of each VLAN, or may require a cable change and then a VLAN configuration change.

Because one centralized control system (NOC 301) is used to monitor and route traffic among several VLANs a high availability observatory (HAO) facility can monitor the entire UDC at once. Systems of the prior art use HAO's at an enterprise level, but the HAO could not penetrate between the network hierarchies from a control plane level to the enterprise level. The present system and method has the advantage that problems with components of any enterprise, or VLAN, within the UDC can be predicted and redundant units within the UDC can be swapped and repaired, even between and among different control planes and VLANs, as necessary. The HAO facility would predict problems, while a facility such as MC/ServiceGuard, available from Hewlett-Packard Company, would facility the swapping of redundant units. If an enterprise is not required to be “always-on” it can operate without redundant units. However, during planned and unplanned system maintenance, the system, or portions of the system may be unavailable. Maintenance and support costs will be favorably affected by the use of the NOC regardless of the always-on capabilities of the individual enterprises.

In an embodiment, the HAO performs two (2) tasks. First, once each day, a remote shell, or execution, (remsh) is launched out to each client/component in the UDC that has been selected for monitoring. The remsh gathers many dozens of configuration settings, or items, and stores the information in a database. Examples of configuration items are: installed software and version, installed patches or service packs, work configuration files, operating configuration files, firmware versions, hardware attached to the system, etc. Analysis can then be performed on the configuration data to determine correctness of the configuration, detect changes in the configuration from a known baseline, etc. Further, a hierarchy of the UDC can be ascertained from the configuration data to produce a hierarchical representation such as shown in FIG. 2. Second, a monitoring component is installed on each selected component in the UDC. The monitoring components send a notification whenever there is a hardware problem. For instance, a memory unit may be experiencing faults, or a power supply may be fluctuating and appear to be near failure. In this way, an operator at the NOC 301 level or support node 350 level can prevent or mitigate imminent or existing failures. It will be apparent to one skilled in the art that a monitoring component can be deployed to measure any number of metrics, such as performance, integrity, throughput, etc.

This monitoring and predictive facility may be combined with a system such as MC/ServiceGuard. In systems of the prior art, MC/ServiceGuard runs at the enterprise level. If a problem is detected on a primary system in an enterprise, a fail over process is typically performed to move all processes from the failed, or failing, component to a redundant component already configured on the enterprise. Thus, the HAO monitors the UDC and predicts necessary maintenance or potential configuration changes. If the changes are not made before a failure, the MC/ServiceGuard facility can ensure that any downtime is minimized. Some enterprise customers may choose not to implement redundant components within their enterprise. In this case, oversight of the enterprise at the NOC or support node level can serve to warn the customer that failures are imminent and initiate maintenance or upgrades before a debilitating failure.

In current systems, an NOC (301) could not monitor or penetrate through the firewall to the control plane cluster layer (311, 321), or to the enterprise layer (VLAN/MDC 313, 315, 317, 323, 325, 327). In contrast, the present system and method is able to deploy agents and monitoring components at any level within the UDC. Thus, the scope of service available with an HAO is expanded. The inherent holes in the communication mechanisms used to penetrate the firewalls are used.

The communication mechanism is XML (eXtended Markup Language) wrapped HTTP (hypertext transfer protocol) requests that are translated by the local agents into the original HAO support actions and returned to the originating support request mechanism. HTTP may be used for requests originating from outside the customer enterprise. SNMP (simple network management protocol) may be used as a mechanism for events originating within the customer enterprise. This and other “client originated events” can be wrapped into XML objects and transported via HTTP to the support node 350. In alternative embodiments, the support node 350 can be anywhere in the UDC, i.e. at the control plane level NOC level, or even external to the UDC, independent of firewalls.

The purpose of a firewall is to block any network traffic coming through. Firewalls can be programmed to let certain ports through. For instance, a firewall can be configured to allow traffic through port number 8080. HTTP (hypertext transfer protocol) messages typically use port number 8080. In systems of the prior art, an HAO is configured to communicate through many ports using remote execution and SNMP communication mechanisms. These mechanisms are blocked by the default hardware and VLAN firewalls. In the present system and method, a single port can be programmed to send HAO communications through to the control plane and enterprise layers. Fewer holes in the firewall are preferred, for ease of monitoring, and minimization of security risks.

Similar to the architecture of SOAP (Simple Object Access Protocol), a series of messages or requests can be defined to proxy support requests through firewalls. An example is a “configuration collection request.” The collection request is encapsulated in an XML document sent via HTTP through the firewall to the local agent within the firewall. The local agent does the collection via remsh as is done in the existing HAO. The remsh is performed within a firewall and not blocked. The results of the request are packaged up in an XML reply object and sent back through the firewall to the originating requesting agent.

Referring again to FIG. 2, the control plane can provide proxy support within the UDC control plane firewall 285. For instance, 10-15 different ports might be needed to communicate through the firewall 275. It is desirable to reduce the number of ports, optimally to one. A proxy mechanism on each side reduces the number of required ports, while allowing this mechanism to remain transparent to the software developed using multiple ports. This enables each VLAN to use a different port, as far as the monitoring tools and control software is concerned. Thus, the existing tools do not need to be re-coded to accommodate drilling a new hole through the firewall each time a new VLAN is deployed.

Another example is an event generated within a control plane. A local “event listener” can receive the event, translate it into an XML event object, and then send the XML object through the firewall via HTTP. The HTTP listener within the NOC can accept and translate the event back into an SNMP event currently used in the monitoring system.

An advantage of the UDC architecture is that a baseline system can be delivered to a customer as a turnkey system. The customer can then add control plane clusters and enterprises to the UDC to support enterprise customers, as desired. However, the UDC operator may require higher-level support from the UDC developer. In this case, a support node 350 communicates with the NOC 301 via a firewall 395 to provide support. The support node monitors and maintains resources within the UDC through holes in the firewalls, as discussed above. Thus, the present system and method enables a higher level of support to drill down their support to the control plane and VLAN levels to troubleshoot problems and provide recommendations. For instance, spare memory components 319 may exist in the control plane 311. The support node 350 may predict an imminent failure of a memory in a specific enterprise 313, based on an increased level of correction on data retrieval (metric collected by a monitoring agent). If this spare 319 is not configured as a redundant component in an enterprise, a system such as MC/ServiceGuard cannot swap it in. Instead, the support node 350 can deploy the changes in configuration through the firewalls, and direct the control plane cluster to reconfigure the spare memory in place of the memory that will imminently fail. This method of swapping in spares saves the enterprise customers from the expense of having to maintain additional hardware. The hardware is maintained at the UDC level, and only charged to the customer, as needed.

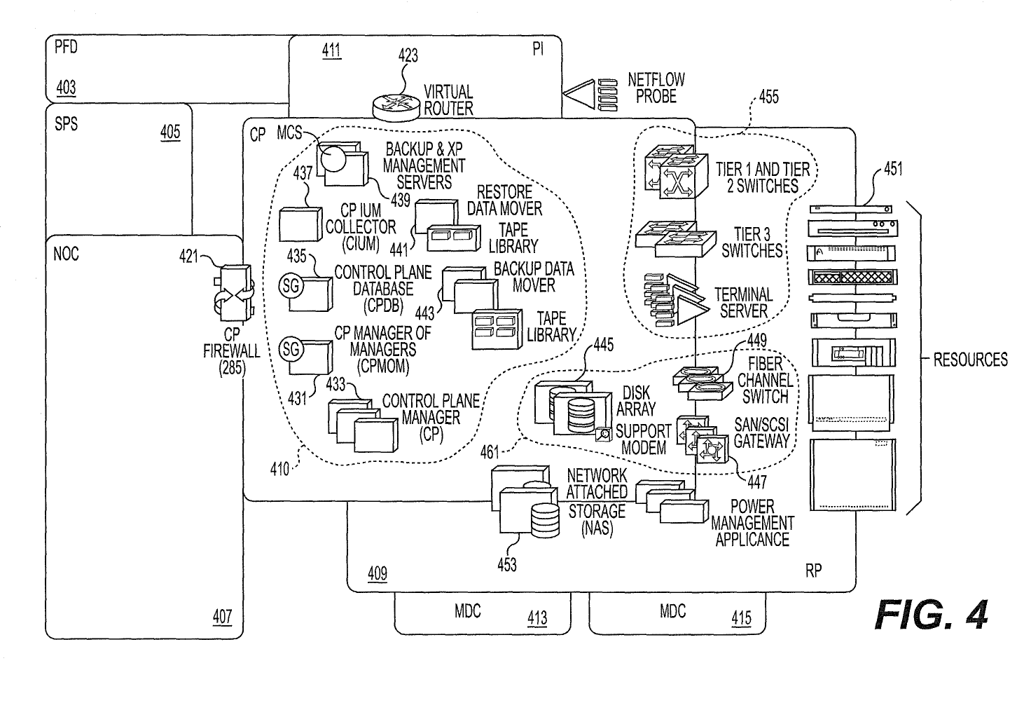

Referring now to FIG. 4, there is shown a more detailed view of an embodiment of a control plane management system (410, comprising: 431, 433, 435, 437, 439, 441, and 443) (an alternative embodiment to the control plane manager of FIGS. 1, 2 and 3) within a UDC 400. Several components of the UDC are shown, but at different levels of detail. In this figure, adjacent components interface with one another. The control plane (CP) 401 is shown adjacent to the public facing DMZ (PFD) 403, secure portal segment (SPS) 405, network operation center (NOC) 407, resource plane (RP) 409 and the Public Internet (PI) 411. The various virtual LANs, or mini-data centers (MDC) 413 and 415 are shown adjacent to the resource plane 409 because their controlling resources, typically CPUs, are in the RP layer.

The control plane 401 encompasses all of the devices that administer or that control the VLANs and resources within the MDCs. In this embodiment, the CP 401 interacts with the other components of the UDC via a CP firewall 421 for communication with the NOC 407; a virtual router 423 for communicating with the PI 411; and a number of components 455 for interacting with the resource plane (RP) 409 and MDCs 413, 415. A control plane manager of managers (CPMOM) 431 controls a plurality of control plane managers 433 in the CP layer 401. A number of components are controlled by the CPMOM 431 or individual CP 433 to maintain the virtual networks, for instance, CP Database (CPDB) 435; Control Plane Internet Usage Metering (CP IUM) Collector (CPIUM) 437, using Netflow technology on routers to monitor paths of traffic; backup and XP management servers 439; restore data mover and tape library 441; and backup data mover and tape library 443. These devices are typically connected via Ethernet cables and together with the CPMOM 431 and CP manager 433 encompass the control plane management system (the control plane manager of FIGS. 1-3). There may be network attached storage (NAS) 453 which is allocated to a VLAN by the CP manager, and/or disk array storage 445 using either SCSI or fiber optic network connections and directly connected to the resources through fiber or SCSI connections. The disk array 445, fiber channel switches 449, and SAN/SCSI gateway 447 exist on their own fiber network 461. The resources 451 are typically CPU-type components and are assigned to the VLANs by the CP manager 433.

The CP manager 433 coordinates connecting the storage systems up to an actual host device in the resource plane 409. If a VLAN is to be created, the CP manager 433 allocates the resources from the RP 409 and talks to the other systems, for instance storing the configuration in the CPDB 435, etc. The CP manager 433 then sets up a disk array 445 to connect through a fiber channel switch 449, for example, that goes to a SAN/SCSI gateway 447 that connects up to resource device in the VLAN. Depending on the resource type and how much data is pushed back and forth, it will connect to its disk array via either a small computer system interface (SCSI), i.e., through this SCSI/SAN gateway, or through the fiber channel switch. The disk array is where a disk image for a backup is saved. The disk itself doesn't exist in the same realm as where the host resource is because it is not in a VLAN. It is actually on this SAN device 447 and controlled by the CP manager 433.

Things that are assigned to VLANs are things such as a firewall, that an infrastructure might be built, and a load balancer so that multiple systems can be hidden behind one IP address. A router could be added so that a company's private network could be added to this infrastructure. A storage system is actually assigned to a host device specifically. It is assigned to a customer, and the customer's equipment might be assigned to one of the VLANs, but the storage system itself does not reside on the VLAN. In one embodiment, there is storage that plugs into a network and that the host computer on a VLAN can access through Ethernet network. Typically, how the customer hosts are connected to the disk storage is through a different network, in one embodiment, through a fiber channel network 461. There is also a network attached storage (NAS) device 453, whereas the other storage device that connects up to the host is considered a fiber channel network storage device. The NAS storage device 453 connects through an Ethernet network and appears as an IP address on which a host can then mount a volume. All of the delivery of data is through Ethernet to that device.

The control plane manager system 410 has one physical connection for connecting to multiples of these virtual networks. There is a firewall function on the system 410 that protects VLAN A, in this case, and VLAN B from seeing each others data even though the CP manager 433 administers both of these VLANs

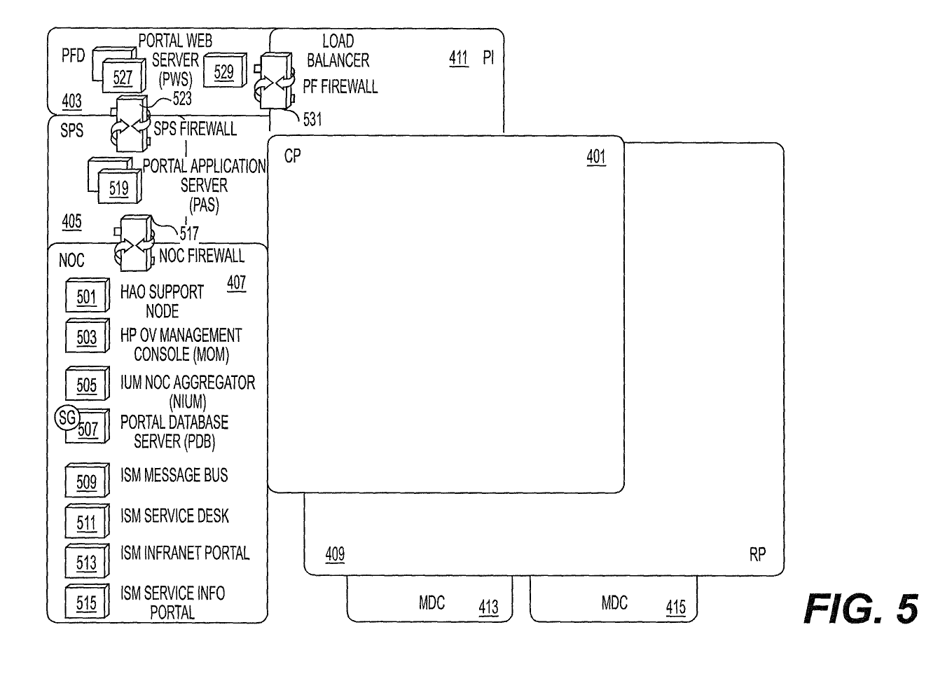

Referring now to FIG. 5, there is shown a more detailed view of the NOC layer of the UDC 400. The NOC 407 is connected to the CP 401 via firewall 421 (FIG. 4). In an exemplary embodiment within the NOC 407 is a HAO support node 501, HP OpenView (OV) Management Console 503 (a network product available from Hewlett-Packard Company for use in monitoring and collecting information within the data center), IUM NOC Aggregator (NIUM) 505, portal database server (PDB) 507, ISM message bus 509, ISM service desk 511, ISM intranet portal 513, and ISM service info portal 515. The NOC 407 interfaces with the secure portal segment (SPS) 405 via a NOC firewall 517. The SPS 405 has a portal application server (PAS) 519. The SPS 405 interfaces with the public facing DMZ (PFD) 403 via a SPS firewall 523. These two firewalls 517 and 523 make up a dual bastion firewall environment. The PFD 403 has a portal web server (PWS) 527 and a load balancer 529. The PFD 503 connects to the PI 411 via a PF firewall 531.

The PFD 403, SPS 405 and NOC layer 407 can support multiple CP layers 401. The control planes must scale as the number of resources in the resource plane 409 and MDCs 413 and 415 increase. As more MDCs are required, and more resources are utilized, more control planes are needed. In systems of the prior art, additional control planes would mean additional support and controlling nodes. In the present embodiment, the multiple control planes can be managed by one NOC layer, thereby reducing maintenance costs considerably.

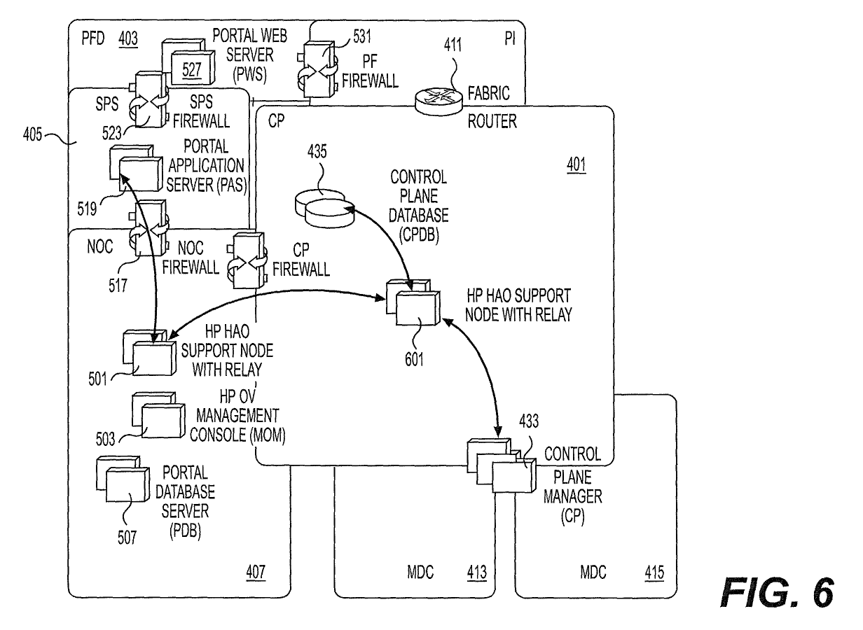

Referring now to FIG. 6, there is shown an exemplary management structure for a high availability observatory (HAO) support model. The HP HAO support node with relay 601 has access to the control plane database (CPDB) 435 to pull inventory and configuration information, as described above for a simple UDC. The HP HAO support node 601 residing in the control plane consolidates and forwards to the NOC for the UDC consolidation. In an embodiment, a support node (SN) resides at the NOC level 501 and/or at an external level 350 (FIG. 3). The support node 601 is a virtual support node (VSN), or proxy, that listens for commands from SN 501 and performs actions on its behalf and relays the output back to SN 501 for storage or action. Each CP manager system can run multiple VSN instances to accommodate multiple VLANs, or MDCs, that it manages. The CP manager system 433 then consolidates and relays to a consolidator in the CP. The NOC support node 501 consolidates multiple CPs and provides the delivery through the Internet Infrastructure Manager (IIM) portal, also known as UDC Utility Data Center Utility Controller (UC) management software, for client access. This method can scale up or down depending on the hierarchy of the data center. For instance, a support node 350 (FIG. 3) may interact with a VSN at the NOC level in order to monitor and support the NOC level of the UDC. It may also interact with VSNs at the CP level in order to monitor and support the CP level of the UDC.

The control plane management system has one physical connection that connects to multiples of these virtual networks. There is a firewall function on the CP management system that protects VLAN A, in the exemplary embodiment, for instance, and VLAN B from seeing each other's data even though the control plane management system is administrating both of these VLANs. The VLANs themselves are considered an isolated network.

Information still needs to be communicated back through the firewall, but the information is gathered from multiple networks. The VLAN tagging piece of that gathering is the means by which this data is communicated. In the typical network environment of the prior art, there are multiple network interfaces. Thus, a system would have to have multiple cards in it for every network that it is connecting to. In the present system, the CP management system only has one connection and uses this communication gateway to see all of the networks (VLANs) and transfer information for these VLANs up to the support node by using VLAN tagging in the card.

Information can be sent back and forth from the CP management system to the VLANs, but by virtue of the protocol of the gateway, information cannot be sent from one VLAN to the other. Thus, the information remains secure. This gateway is also known as a VLAN tag card. This type of card is currently being made by 3COM and other manufacturers. The present system differs from the prior art because it securely monitors all of the HAO through this one card.

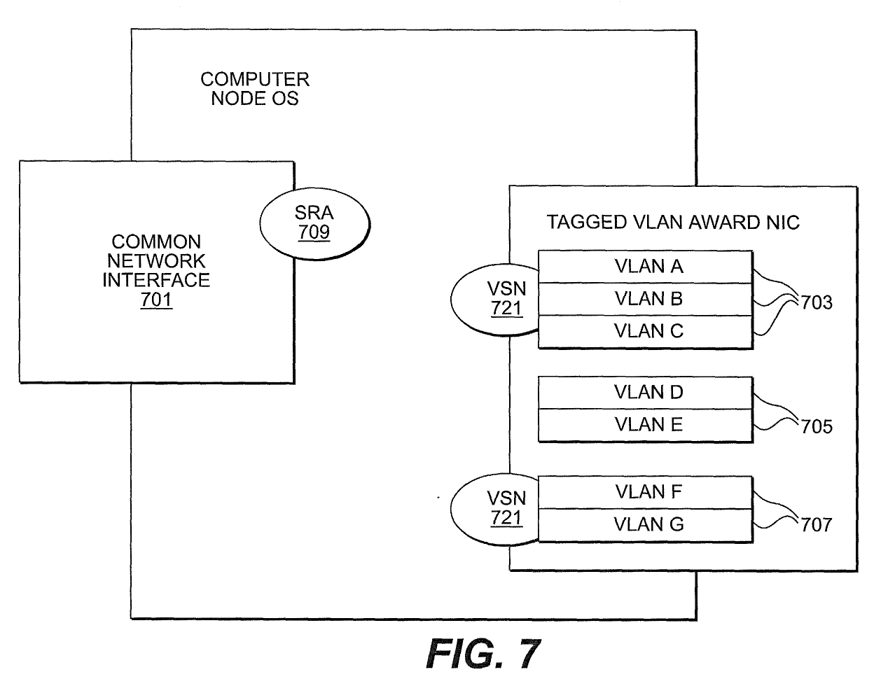

Referring now to FIG. 7, there is shown the common network interface card and its interaction with the VLANs. The CP management system sees all of the resource VLANs; it has a common network interface card 701 with a firewall piece (not shown). A gateway is created with the HAO that allows it to perform the HAO support functions. The virtual support nodes (VSN) 721 connect to all of these different VLANs 703, 705, 707 through one interface. The support relay agent (SRA) 709 communicates all of the secure information through the common network interface 701. The SRA 709 is used to translate support requests specific to the virtual support nodes into “firewall save” communications. For example, HTTP requests can be made through the firewall where they get proxied to the actual support tools. The existing art of “SOAP” (Simple Object Access Protocol) is a good working example as to how this would work. This is predicated on the currently acceptable practice of allowing holes in firewalls for HTTP traffic. The virtual support node uses the industry standard and accepted protocol of HTTP to drill through the firewalls. Utilizing a SOAP type mechanism, collection requests and client-originated events are wrapped in XML objects and passed through the firewall between “HAO Proxies.”

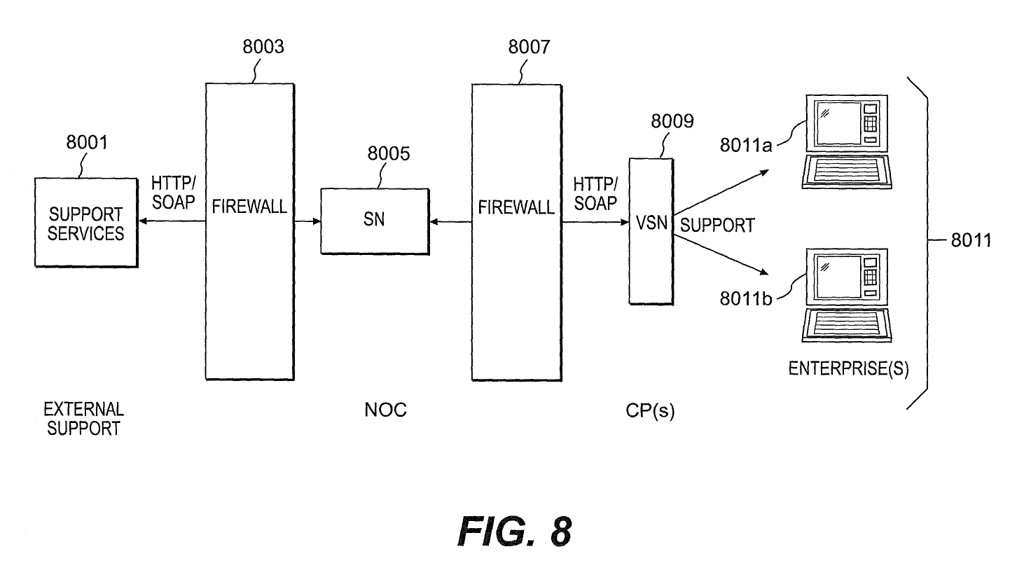

Referring now to FIG. 8, there is shown a block diagram of support services through firewalls as relates to a data center. Standard support services 8001 such as event monitoring and configuration gathering can be accomplished remotely in spite of the existence of firewalls 8003 and 8007 by using HTTP based requests. By leveraging technologies such as Simple Object Access Protocol (SOAP), the Support Node (SN) 8005 can package up requests such as a collection command in an XML object. The request can be sent to a “Support Proxy,” or virtual support node (VSN) 8009 on the other side of the firewall 8007. A VSN 8009 on the other side of the firewall 8007 can translate that request into a collection command, or any other existing support request, that is run locally as though the firewall 8007 was never there.

For example, a request to gather the contents of the ‘/etc/networkrc’ file from enterprise 8011a in a control plane might be desired. There is a SN 8005 in the NOC and a VSN 8009 inside the Control plane. The request for /etc/networkrc is made from the SN 8005. The request is packaged as an XML SOAP object. The request is sent to the VSN 8009 inside the CP, and through the CP's firewall (not shown). The VSN 8009 hears the HTTP based SOAP request and translates it into a remote call to get the requested file from the enterprise 8011a. The VSN 8009 packages up the contents of the requested file into another XML SOAP object and sends it back to the SN 8005.

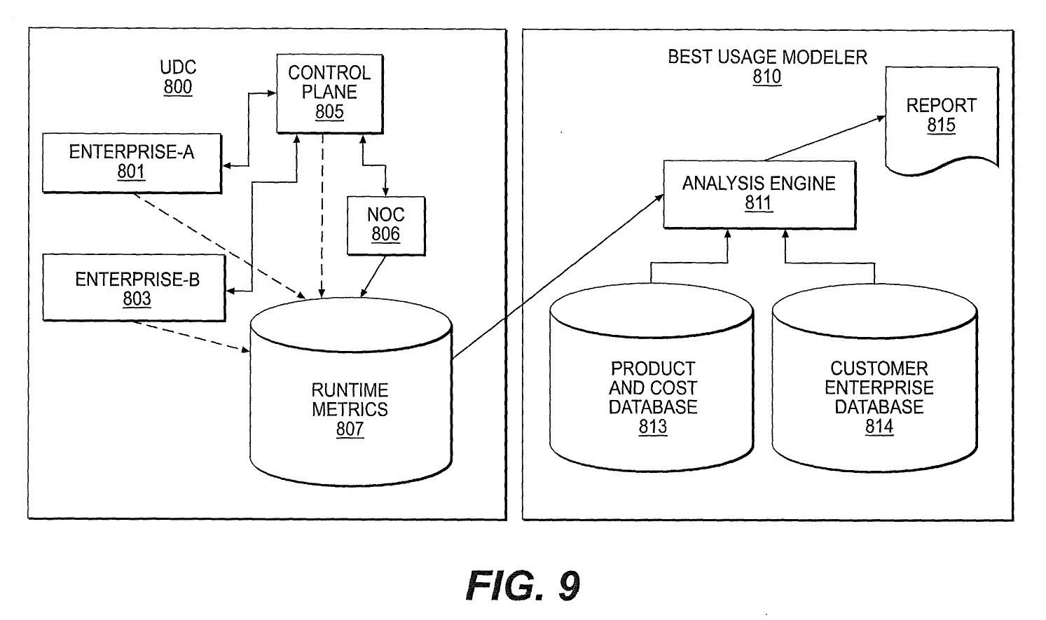

Referring now to FIG. 9, there is shown a block diagram of a UDC with multiple customer enterprises of computing resources, and the interaction with the best usage modeler system. In this exemplary embodiment, the UDC 800 has two enterprises enterprise-A 801 and enterprise-B 803. These mini-data centers are connected to a UDC control plane 805. Performance metrics and configuration information for an enterprise may be collected at the enterprise 801 and 803, control plane 805 or NOC 806 level using the methodology described above to monitor enterprises and communicate through firewalls. A variety of methods may be used to collect and store the configuration, metrics and performance data. In an alternative embodiment, the customer enterprise is a stand-alone network. In this case, the run-time metrics are collected directly at the enterprise level and stored in the metric database 807. In another embodiment, the control plane 805 collects run-time metrics and performance data of the enterprises on an ongoing basis and stores this information in the run-time metrics database 807. It will be apparent to one skilled in the art that this database could be a file database stored on a hard drive or other means. In an alternative embodiment, a network operation center (NOC) 806 collects the metrics for the enterprises and control planes at a higher level. In another embodiment, an HAO runs at the enterprise level and saves the metrics and stores them into a database. Once the enterprise configuration and metrics are collected, they are off-loaded onto a remote system 810 for analysis. Thus, ROI analysis is performed without impacting the on-going performance of the enterprise. The best usage modeler 810 has an analysis engine 811 connected to a product database 813 and a customer enterprise database 814. The analysis engine also pulls data from the run-time metric database 807.

The product database 813 contains information on hardware and software components that would be in a typical enterprise, including cost data and also substitution information, preferred replacements and maintenance costs. The customer enterprise database 814 contains configuration, cost, and performance information collected from existing enterprises that are being remotely monitored. For instance, existing customer enterprises are monitored and their configuration data is stored. An existing enterprise E might have been upgraded from 50 to 100 computers at a cost of n dollars. The enterprise E is of a certain type, for instance a web site server. The current and past configuration information for enterprise E is stored in the customer enterprise database 814 for historical comparison. Thus, the consequences of upgrades and hardware or software substitution for similar enterprises can be determined. All performance criteria that are monitored for each enterprise are stored in the customer enterprise database 814. For instance, historical information stored for customer enterprises includes values for dollar per unit throughput, dollar per web pages serviced, dollars per memory access speed, CPU speeds, thresholds for acceptable parameters, query times, etc.

The analysis engine 811 uses existing commercial-off-the-shelf (COTS) tools for performance analysis as well as a custom tool that ties in the performance and run-time metrics with the cost data in the product database. The engine looks in the customer enterprise database for any and all like enterprises, for further comparison. The “like” enterprise information in the customer enterprise database 814 is used for examples of enterprises exhibiting better or worse performance with similar configurations. This information is combined with the product database 813 to identify recommendations or planning results for specific changes to the subject's computing environment. Once an analysis has been performed, the return on investment (ROI) information, as well as recommendations for upgrades or downgrades or replacements of components within each enterprise and/or UDC, is reported in block 815.

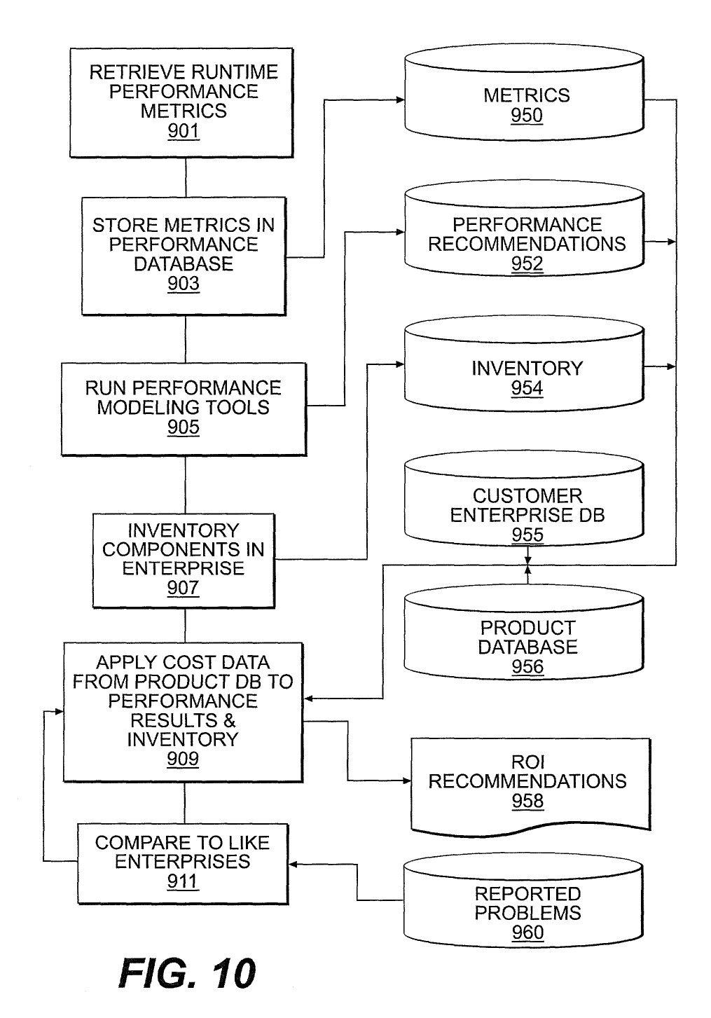

Referring now to FIG. 10, there is shown a flow diagram of an exemplary method used to analyze the run-time metrics combined with the cost information in the product database. The remote support toolset retrieves run-time performance metrics of each system in the customer's computing environment in step 901. The metrics are stored in a performance/metrics database 950 in step 903. A set of existing COTS tools is used to run performance modeling in order to make performance recommendations for the individual enterprises in step 905. For instance, MeasureWare or OpenView Performance Manger products available by Hewlett-Packard Company may be used to collect appropriate performance metrics. Other tools may be used, as desired. Data from the customer enterprise database 955 is used for historical performance comparison. The recommendations are stored in a database 952. An inventory is made of all components in the individual enterprises in step 907 and stored in a database 954. In an alternative embodiment, the configuration data is retrieved from a backup image which is loaded in a remote system, thereby reducing the load on the source enterprise. It will be apparent to one skilled in the art that the databases 950, 952 and 954 may be informal databases stored locally in memory until such time when analysis is performed on them; they need not be stored in a physical device other than RAM, or similar volatile memory. Cost data is retrieved from the product database 956 based on the inventory of components in the enterprise. This cost data is applied to the performance results and inventory in step 909 to produce a return on investment recommendation 958, which includes recommendations for upgrading, downgrading or replacing certain components in order to make the enterprise more cost effective, while maintaining a high level of performance.

One algorithm that may be used with an embodiment of the invention uses a cost per performance metric. In the case of I/O (input/output), a value like $100 per mb/sec could be used as a unit per measurement threshold. Other thresholds or units may be used, as desired by the customer. For instance, customers in the United Kingdom would use Pounds Sterling instead of U.S. dollars for £85 per mb/sec. This provides a way to quantify what a “realistic” cost is to reach a certain performance level. The algorithm also applies to $ per CPU cycles, $ per memory access, etc. In another embodiment of the invention the method tries to estimate what would happen by adding dollars to the enterprise. Current performance analysis tools merely point out bottlenecks (i.e., recommend adding more memory, disc drives, etc). A customer might have a specified amount of money to invest in increased performance. Also, the customer will want to know the cost of performance recommendations without specifying a cap. The present method makes recommendations (958) and associates a cost, derived from the product database (956), to them. In another embodiment, the price/performance values for a customer are graphed against all the other instances of similar (or dissimilar) enterprises that are retrieved from world-wide database (customer enterprise database 955).

In an alternative embodiment, the customer specifies an upgrade or specific addition to the computing environment, and the analysis engine looks for existing enterprises in the customer enterprise database 955 that have made similar changes. One or more ROI recommendations 958 are made based on the current enterprise configuration and the historical data retrieved from the customer enterprise database 955. The recommendation report 815 embodies the results of those “like changes”.

In an alternative embodiment, recommendations made for individual enterprises are enhanced by comparing like enterprises in block 911. Typically, in an enterprise, when problems occur or faults occur a database is kept with problem reports which will highlight whether or not the system is performing optimally or whether the users believe it is too slow or too faulty, for instance, when down-time is excessive. The problem data stored in a database 960 is used to compare the performance results of like enterprises to determine whether or not a specific configuration is performing better than another configuration for similar enterprises. This comparison data is used with the cost data for the varying components to perform a further analysis to make recommendations that would upgrade or modify a certain enterprise to be more like an enterprise that has been determined to be better or more optimal in performance.

Several advantages result from the use of a world-wide customer enterprise database. “Like” configured systems can be found and compared to the target system. From comparing like systems, the minor differences are identified and these differences are estimated in terms of both cost and performance. The estimate is the used to estimate what would happen to cost and performance of the target system if similar changes were made to the customer's environment to make it more similar to the system configuration retrieved from the database. For instance, in one embodiment HP's measurement tool MeasureWare is used to get the performance numbers for CPU, Memory, I/O, etc. Two examples, below, illustrate how some embodiments of the system might be used.

### EXAMPLE 1

A customer has a system with $25,000 in memory in their environment of three HP-UX Servers. This breaks down to four (4) Gb of memory in their three N-class Servers. This customer's enterprise is currently using around 95% of their memory most of the time, and are frequently hitting 100% usage. In order to make a recommendation, the level of swap usage is investigated (i.e., what is being swapped out because memory is full) and it is determined that another Gb of memory is warranted. Then the price of this memory is retrieved from the product database and added to the recommendation. Other recommendations (disk space, more processors, etc.) also have the cost associated with them that is retrieved from the product database. Once the full recommendation is examined, the customer can then make a decision quicker based on cost and performance, rather than just performance.

### EXAMPLE 2

For a $25,000 investment, this customer is getting a certain level of throughput, but the customer enterprise database reveals that another customer in our world-wide database has paid ˜$26,000 and is performing with a much higher throughput. The other customer's environment is examined to identify other differences to the target system that might be contributing to the better cost/performance. It is found that the other customer has more swap space configured that is enabling better swapping performance. Thus, a recommendation is made to the customer who owns the target system to reconfigure for more swap space (at a minimal cost), or, optionally, to buy more disk space (with the quoted cost) and applied more swap. It is then suggested that that the customer will see a performance gain similar to our other example customer.

The terms and descriptions used herein are set forth by way of illustration only and are not meant as limitations. Those skilled in the art will recognize that many variations are possible within the spirit and scope of the invention as defined in the following claims, and their equivalents, in which all terms are to be understood in their broadest possible sense unless otherwise indicated.

1. A method for modeling best usage of funds for an enterprise, said method comprising steps of:
retrieving runtime performance metrics from an enterprise customer's environment;
executing at least one performance modeling tool on the runtime performance metrics of the enterprise, the executing being performed remotely from the enterprise;
determining an inventory of components in the enterprise; and
applying cost data from a products database to results of the at least one performance modeling tool, wherein the cost data corresponds to the inventory of components, thereby resulting in return on investment (ROI) recommendations.

2. The method as recited in claim 1, said method further comprising a step of:
comparing the enterprise with one or more like enterprises, wherein reported problems provide a subjective performance measure of a given enterprise.

3. The method as recited in claim 2, wherein the comparing uses data from a world-wide customer enterprise database comprising historical runtime performance metrics, cost data and corresponding information defining upgrades and modifications made for a plurality of enterprises.

4. The method as recited in claim 3, wherein the plurality of enterprises are remotely monitored.

5. The method as recited in claim 1, wherein the runtime performance metrics are retrieved through one or more firewalls by a support node.

6. The method as recited in claim 5, wherein the runtime performance metrics are retrieved through a firewall by an external support node for analysis using a simple object access protocol (SOAP) request mechanism, and wherein simple network management protocol (SMTP) events generated from clients within a firewall are packaged in XML and transported via HTTP (hypertext transfer protocol) listeners.

7. The method as recited in claim 1, wherein the at least one performance modeling tool is a commercial-off-the-shelf tool.

8. The method as recited in claim 1, wherein determining an inventory of components in the enterprise is conducted via one or more firewalls by support node.

9. The method as recited in claim 1, wherein determining an inventory of components in the enterprise is conducted off-line using an image backup of the enterprise.

10. The method as recited in claim 1, wherein a proposed change in a customer's computing environment is checked for effectiveness using historical customer enterprise data for enterprises that have also made a change similar the proposed change.

11. A system for best usage of funds modeling for an enterprise, comprising:
a plurality of components in an enterprise;
a metrics database for storing a plurality of runtime performance metrics for each component in an enterprise;
a product database for storing cost and configuration information corresponding to both components in the enterprise and viable substitute/replacement components;
a customer enterprise database for storing historical data corresponding to a plurality of monitored enterprises; and
an analysis engine for modeling cost information with performance metrics and historical enterprise data, wherein the modeling results in at least one recommendation for maximizing return on investment, given a desired investment amount and a selected enterprise.

12. The system as recited in claim 11, wherein the analysis engine resides remotely from the selected enterprise.

13. The system as recited in claim 11, wherein the enterprise is a virtual local area network (VLAN) in a data center and managed by a control plane means for high availability purposes, and wherein the control plane means is supported by a network operation center (NOC), the VLAN, control plane means and NOC communicating through one or more firewalls.

14. The system as recited in claim 11, wherein the runtime performance metrics are collected by a support node via a firewall using simple object access protocol (SOAP) request mechanism, and wherein SOAP events generated from clients within a firewall are packaged in XML and transported via HTTP (hypertext transfer protocol) listeners.

15. A system for modeling best usage of funds for an enterprise, comprising:
a plurality of components in a target enterprise;
means for collecting run-time performance metrics for each component in the target enterprise;
storage means for storing run-time performance metrics for each component in the target enterprise;
product information storage means for storing cost and configuration information corresponding to components in the target enterprise and viable substitute/replacement components;
customer enterprise information storage means for storing historical data corresponding to a plurality of monitored enterprises; and
means for performing analysis using cost information, performance metrics and historical enterprise data, wherein the analysis results in at least one recommendation for identifying a return on investment (ROI).

16. The system as recited in claim 15, wherein the means for performing analysis uses a desired investment amount to generate at least one ROI recommendation.

17. The system as recited in claim 16, wherein the means for performing analysis uses information retrieved from the customer enterprise information storage means to generate at least one ROI recommendation, wherein the information retrieved corresponds to enterprise investment information for at least one like enterprise.

18. The system as recited in claim 17, wherein performance of the at least one like enterprise is superior to performance of the enterprise.

19. The system as recited in claim 15, wherein the analysis means is external to the enterprise being analyzed.

20. The system as recited in claim 15, wherein the analysis means compares historical enterprise data corresponding to enterprises experiencing a like change to a proposed enterprise change.

21. A method for recommending modifications to a target enterprise relating to the cost effectiveness of the target enterprise, said method comprising steps of:
retrieving runtime performance metrics from a target enterprise customer's environment;
executing at least one performance modeling tool on the runtime performance metrics of the target enterprise, the executing being performed remotely from the target enterprise;
determining an inventory of components in the target enterprise; and
applying cost data from a products database to results of the at least one performance modeling tool, wherein the cost data corresponds to the inventory of components in the target enterprise.

22. The method as recited in claim 21, further comprising:
retrieving information from a customer enterprise database corresponding to at least one like enterprise, wherein the at least one like enterprise is of a type similar to the target enterprise;
comparing performance and cost information of the at least one like enterprise to performance and cost information of the target enterprise; and
generating at least one recommendation report.

23. The method as recited in claim 22, wherein the at least on recommendation report suggests modifications to the target enterprise to cost effectively improve performance.

24. The method as recited in claim 23, wherein the recommendation report suggests modifications to the target enterprise selected from the group consisting of adding components, deleting components, substituting like components, replacing components, and upgrading software.
